(19) United States
(12) Patent Application Publication
(10) Pub. No.: US 2025/0215913 A1
(43) Pub. Date: Jul. 3, 2025

(54) A JOINING SYSTEM FOR PANELS

(71) Applicant: VILOX SYSTEMS AB, Helsingborg (SE)

(72) Inventor: Bobby MARKOVSKI, Helsingborg (SE)

(21) Appl. No.: 18/848,838

(22) PCT Filed: Mar. 21, 2023
(86) PCT No.: PCT/SE2023/050245

§ 371 Date: Sep. 19, 2024

(30) Foreign Application Priority Data
Mar. 23, 2022 (SE) 2250357-7

(51) Int. Cl. F16B 12/26; F16B 5/00

(52) U.S. Cl. CPC F16B 12/26; F16B 5/0016

(57) ABSTRACT

A joining system for panels includes a first panel and a second panel configured to be joined with the first panel. The first panel includes a first and second female coupling recess having a recess length axis, and a first positioning portion between the first and second female coupling recess along the recess length axis. The second panel includes a first and second male coupling tongue having a tongue length axis, and a second positioning portion between the first and second male coupling tongues.

### TECHNICAL FIELD

The invention relates to a joining system for panels, comprising female coupling recesses formed in a first panel adapted to receive male coupling tongues projecting from an adjoining second panel.

### BACKGROUND

In the recent years the furniture industry is gradually replacing traditional fastening and joining methods using nails and screw and nut joining elements with various snap-locking joining systems. This trend vastly facilitates installation of e.g. furniture such as for example bookshelves, wardrobes, and cupboards. Typically, furniture items connected with snap-locking joining systems include a set of furniture parts, a first furniture part having a first main plane and a second furniture part having a second main plane. The furniture parts are provided with a mechanical locking device for locking a first edge of the first furniture part to a second edge of the second furniture part. A common problem of the joining systems in the prior art is a problem that entails complicated and expensive manufacturing processes. A further problem with the prior art systems is lack of stability in certain load direction. In some cases, the lack of structural symmetry, results in insufficient side stability, or bending resistance. Stability may be sufficient when subjected to a force in one direction, but if subjected to a force in another direction, normally the opposite direction, the prior art joining systems may be weaker and eventually flex, deflect or bend in an undesired way. These uneven stability properties of the joints have to be taken into account when designing a piece of furniture, which potentially limits available design options in the design process. A further problem is that the assembly process may require a high degree of precision to have the furniture parts assembled in a correct way. This precision may be both time consuming and require skill of the person connecting the furniture parts, as erroneous assembly of the furniture parts may lead to a finished product which is does not function optimally long term. The same issues and drawbacks with the state of the art exists also an numerous other applications in which panels are joined into larger items.

### SUMMARY

It is an object of the invention to at least partly overcome one or more limitations of the prior art. In particular, it is an object to provide an improved joining system for panels which is less complex to manufacture, which is more robust with an increased multi-directional side stability and which is easier to assemble in a correct way, in comparison with existing joining systems.

In as first aspect of the invention, this is achieved by a joining system for panels comprising a first panel and a second panel configured to be joined with the first panel. The first panel comprises a first and second female coupling recess having a recess length axis and being formed as integral portions of the first panel, and a first positioning portion being formed as an integral portion of the first panel and being placed between the first and second female coupling recess along the recess length axis. The second panel comprises a first and second male coupling tongue having a tongue length axis and being formed as integral portions of the second panel, and a second positioning portion being formed as an integral portion of the second panel and being placed between the first and second male coupling tongues. The first male coupling tongue is configured to be coupled to the first female recess and the second male coupling tongue is configured to be coupled to the second female recess for creating an interlocking engagement between the first and second panel. The first positioning portion is configured to be placed opposite the second positioning portion as the interlocking engagement is created, as such, movement of the second panel in relation to the first panel along the recess length axis is hindered.

The positioning portions helps the person connecting the first and second panels to ensure that the first and second panels are connected in the right position along the recess length axis RLA and tongue length axis TLA, which makes it significantly harder to erroneously connect the second panel to the first panel, which ensures that the long-term functionality as well as the aesthetics of the larger connected item (e.g. a furniture) becomes as intended.

According to one embodiment, the first and second female coupling recess have a depth such that the first and second male coupling tongues can be received in the first and second female coupling recess for creating the interlocking engagement. The first positioning portion hinders the movement of the second panel in relation to the first panel along the recess length axis by not having a depth capable of receiving any one of the first and second male coupling tongues.

According to one embodiment, the first panel has a first length along the recess length axis, and the first positioning portion is placed entirely within the first half of the first length.

According to one embodiment, the first positioning portion is placed entirely within the first ⅓ LA″ of the first length LA.

According to one embodiment, the first panel comprises first planar surface extending on at least two sides of the first and second female coupling recess, and the planar surface is configured to engage a second surface extending on at least two sides of the first and second male coupling tongues.

According to one embodiment, the first positioning portion comprises the planar surface, such that the planar surface extends from at least one side of the first female coupling recess over the first positioning portion to at least one side of the second female coupling recess.

According to one embodiment, the second positioning portion comprises the second surface, such that the second surface extends from at least one side of the first male coupling tongue over the second positioning portion to at least one side of the second male coupling tongue.

According to one embodiment, the first positioning portion comprises the planar surface, such that the planar surface extends from one side of the first female coupling recess over the first positioning portion to one side of the second female coupling recess. Similarly, the second positioning portion may comprise the second surface, such that the second surface extends from one side of the first male coupling tongue over the second positioning portion to one side of the second male coupling tongue.

According to one embodiment, at least one of the first and second male coupling tongues comprises a curvature or chamfer extending between the first and second male coupling tongues and the second surface, along a plane extending from the tongue length axis. The curvature or chamfers makes it easier to manufacture the male coupling tongues and also increases the strength of the male coupling tongues.

According to one embodiment, at least one of the first and second female coupling recess each comprises a clearance recess configured to receive the curvature or chamfer. In the embodiment of FIG. 4, the clearance recess is less than ⅓ of the depth of the first and second female coupling recess.

The first female coupling recesses may comprise an open end. The open end enables a coupling release rod to access and be positioned in the coupling release channel for decoupling the second panel from the first panel.

At least one of the first and second female coupling recesses comprises a first recess portion comprising locking means and a second recess portion devoid of locking means. The first recess portion RP1 may have an average width, and the second recess portion may have an average width. The average width of the second recess portion may be wider than the average width of the first recess portion. This enables a milling tool for milling the first and second female coupling recesses to enter and exit the recess at the second recess portion.

The joining system may in any one of the embodiments herein comprise a female coupling recess formed in a first panel, a male coupling tongue projecting from an adjoining second panel, said female coupling recess being adapted to receive the male coupling tongue, said male coupling tongue comprising a first locking element configured for a snap joint interlocking engagement with a matching second locking element in said female coupling recess. The male coupling tongue being configured to be more flexible than the female coupling recess. The joining system comprises an upper guiding surface arranged on a first side of the female coupling recess on the first panel, forming an essentially non-resilient guide for the male coupling tongue upon insertion thereof, limiting movement of said male coupling tongue in a direction towards said first side of the female coupling recess. The joining system further comprising a lower guiding surface arranged on a second side of the female coupling recess on the first panel, located opposite to said first side thereof, said lower guiding surface being configured to force the male coupling tongue to resiliently deflect whilst in engagement with said upper guiding surface upon further insertion thereof in a deflection movement towards said first side of the female coupling recess, until the first locking element of the male coupling tongue snaps together with the matching second locking element of the female coupling recess. The lower guiding surface at its lowest end transitions into a lateral locking surface extending essentially parallelly to a longitudinal direction of the female coupling recess, said lateral locking surface is configured to exert a horizontal pressure on the male coupling tongue towards said first side of the female coupling recess, holding the first and second locking elements of the male coupling tongue and the female coupling recess in engagement with each other in a joined state between the first panel and the second panel.

Having a lower guiding surface configured to force the male coupling tongue to resiliently deflect whilst in engagement with said upper guiding surface upon further insertion thereof in a deflection movement towards said first side of the female coupling recess, until the first locking element of the male coupling tongue snaps together with the matching second locking element of the female coupling recess, provides for a robust joining system with an increased multi-directional side stability, while being less complex to manufacture.

The female coupling recess may comprise a coupling release channel adapted for receiving a coupling release rod to engage with the male coupling tongue and force the male coupling tongue to snap out of its engagement with the locking groove in the female coupling recess, so as to deliberately separate the first panel from the second panel.

The coupling release channel may be located in the bottom of the female coupling recess, such that the coupling release rod engages the distal, lower, end portion of the male coupling tongue for creating a vertical force pushing the male coupling tongue vertically out of the female coupling recess.

Having a coupling release channel integrated in the female coupling recess provides for a joining system which is less complex to manufacture, easier to recycle, robust but yet allows for easy disassembly if desired.

The female coupling recess may have a length-axis which is extending horizontally, parallelly to the plane of the extension of the first panel, such that a wedge-shaped coupling release rod having an elongated cross-section may be inserted into the coupling release channel.

The coupling release rod may be at least partly tapered having an increasing cross-sectional area from, or at a distance from, a tip portion thereof towards a base portion thereof. The coupling release rod may comprise an introductory section with a constant cross-sectional area, extending from said tip portion to a tapered unlocking section with an increasing cross-sectional area towards the base portion of said coupling release rod.

The method for unlocking the joining system may comprise angling the second panel relative to the first panel, or vice versa, following initial unlocking of a first stretch of a panel joint, said angling resulting in progressive unlocking of a remaining stretch of said panel joint.

The joining system could in any of the preceding embodiments be a joining system for joining furniture parts, and in which case the first panel could be a first furniture part and the second panel could be a second furniture part. The joining system could in other embodiments be a joining system for structural components in house construction of elements for constructing the inner or outer walls of a house.

Still other objectives, features, aspects and advantages of the invention will appear from the detailed description as well as from the drawings.

### BRIEF DESCRIPTION OF THE DRAWINGS

Embodiments of the invention will now be described, by way of example, with reference to the accompanying schematic drawings.

FIG. 1 shows a side view of a joining system according to an example of the disclosure, applied on an exemplifying basic 90-degree joint between two panels. The figure shows the joining system in a state in which the male coupling tongue of the second panel is being inserted into the female coupling recess of the first panel.

FIG. 2 shows a side view similar to the one in FIG. 1, only here in a state just before the male coupling tongue of the second panel becomes fully engaged in the female coupling recess of the first panel.

FIG. 3a shows a side view of the joining system of FIG. 1, only here in a state in which the male coupling tongue of the second panel has been fully inserter and engaged in the female coupling recess of the first panel, such that the snap-lock has been created. FIG. 3a further shows that the insertion portion of the coupling release rod of FIG. 3b has been inserted into the coupling release channel of the female coupling recess.

FIG. 3b shows a sideview of a wedge-shaped coupling release rod according to an example of the disclosure, where a tapering unlocking section exhibits a linear tapering profile.

FIG. 3c shows a side view of the joining system of FIG. 1, only here in a state in which an unlocking section of a wedge-shaped coupling release rod has entered the coupling release channel, creating a vertical force forcing on the male coupling tongue causing the male coupling tongue to disengage from the female coupling recess and thereby deliberately separating the second panel from the first panel.

FIG. 4a shows a perspective overview of the engaging or disengaging of a second panel from a first panel. FIG. 4a also shows the coupling release rod as well as enlargements of a first positioning portion of the first panel and of a second positioning portion of the second panel.

FIG. 4b shows a perspective overview of the engaging or disengaging of a second furniture part from a first furniture part. FIG. 4b also shows the coupling release rod as well as enlargements of a first positioning portion of the first furniture part and of a second positioning portion of the second furniture part.

FIG. 4c shows a perspective overview of a parallel engaging or disengaging of a second panel from a first panel. The application could for example be for connecting two panels being parts of a table. FIG. 4c also shows the coupling release rod as well as enlargements of a first positioning portion of the first panel and of a second positioning portion of the second panel.

FIG. 4d shows a perspective overview of a parallel engaging or disengaging of a second panel from a first panel. In the embodiment of FIG. 4d, the end portion is closed. The application could for example be for connecting two panels being parts of a table. FIG. 4d also shows enlargements of a first positioning portion of the first panel and of a second positioning portion of the second panel.

FIG. 4e shows a perspective overview of an engaging or disengaging of a second panel from a first panel. In the embodiment of FIG. 4e, the panels are engaged by means of angling, but the end result after joining will have the same planar surfaces as in the embodiments of FIGS. 4c and 4d. The application could for example be for connecting two panels being parts of a table. FIG. 4e also shows enlargements of a first positioning portion of the first panel and of a second positioning portion of the second panel.

### DETAILED DESCRIPTION

Embodiments of the invention will now be described more fully hereinafter with reference to the accompanying drawings, in which some, but not all, embodiments of the invention are shown. The invention may be embodied in many different forms and should not be construed as limited to the embodiments set forth herein.

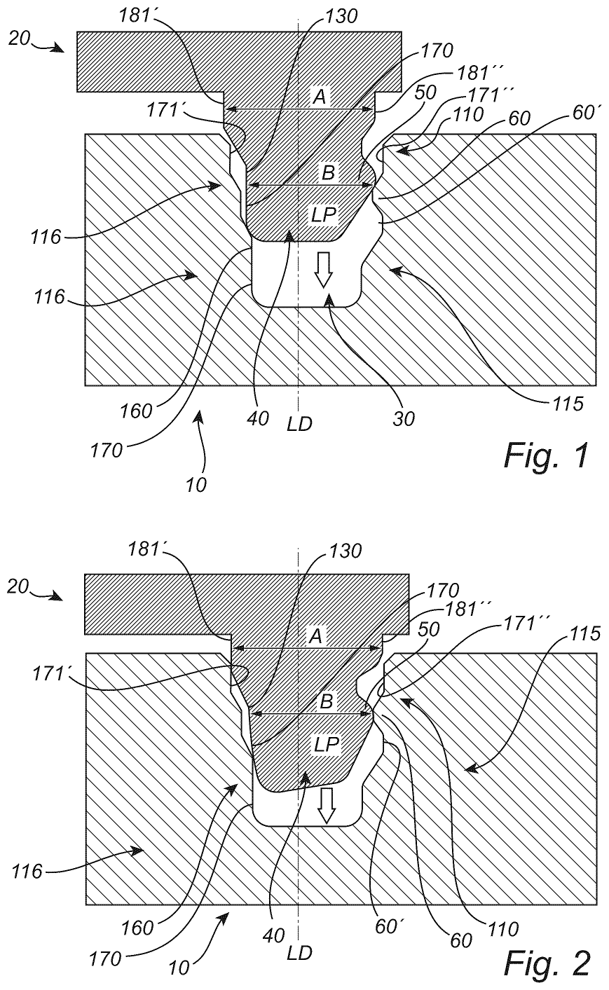

FIG. 1 is a schematic illustration of a joining system for panels 10, 20 for forming larger joint items, such as for example pieces of furniture. The joining system comprises a female coupling recess 30 formed in a first panel 10, and a male coupling tongue 40 projecting from an adjoining second panel 20. The female coupling recess 30 is adapted to receive the male coupling tongue 40, and the male coupling tongue 40 comprises a first locking element 50 configured for a snap joint interlocking engagement with a matching second locking element 60 in the female coupling recess 30. The male coupling tongue 40 is configured to be more flexible than the female coupling recess 30.

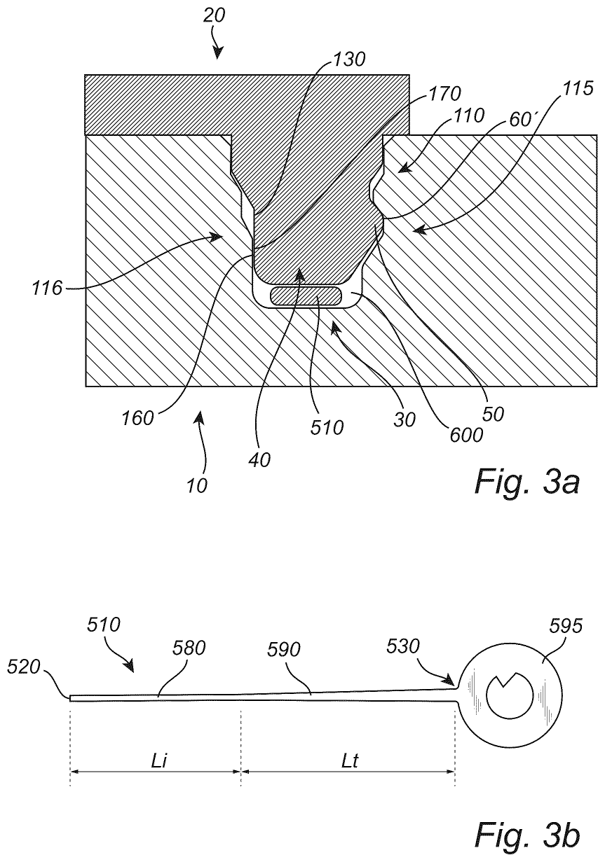

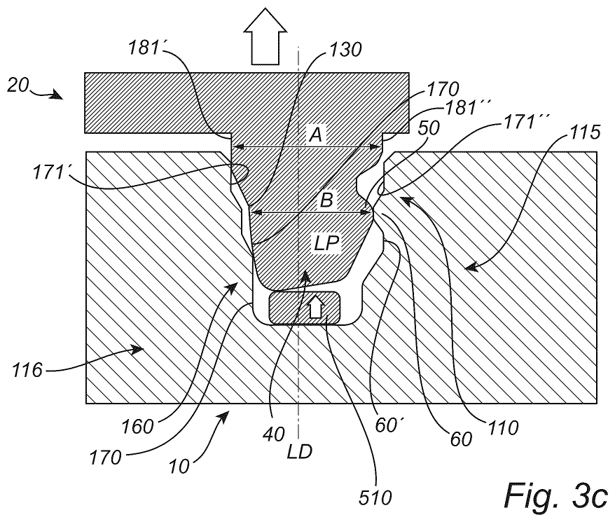

The material surrounding the female coupling recess 30 is thus more rigid than the male coupling tongue 40. The male coupling tongue 40 may be configured to be essentially resilient whereas the female coupling recess 30 is configured to be essentially rigid and non-resilient. An upper guiding surface 110 is arranged on a first side 115 of the female coupling recess 30 on the first panel 10. The upper guiding surface 110 forms an essentially rigid or non-resilient guide for the male coupling tongue 40 upon insertion thereof, limiting movement of the male coupling tongue 40 in a direction towards the first side 115 of the female coupling recess 30. The joining system comprises a lower guiding surface 160 arranged on a second side 116 of the female coupling recess 30 on the first panel 10, located opposite to said first side 115 thereof. The lower guiding surface 160 is configured to force the distal, or lower, portion LP (e.g. the lower half) of the male coupling tongue 40 to resiliently deflect. The lower portion LP of the male coupling tongue 40 is deflected towards the first side 115 of the female coupling recess 30, until the first locking element 50 of the male coupling tongue 40 snaps together with the matching second locking element 60 of the female coupling recess 30, i.e. to assume the joined state shown in FIG. 3a.

In the embodiment shown in FIGS. 1-4, the first locking element 50 may comprise an integral protrusion 50 integrally formed in the male coupling tongue 40. The protrusion 50 may extend in a direction essentially perpendicular to a longitudinal direction LD in which the male coupling tongue 40 extends. The second locking element 60 may comprise a recess or locking groove 60′ for receiving the protrusion 50.

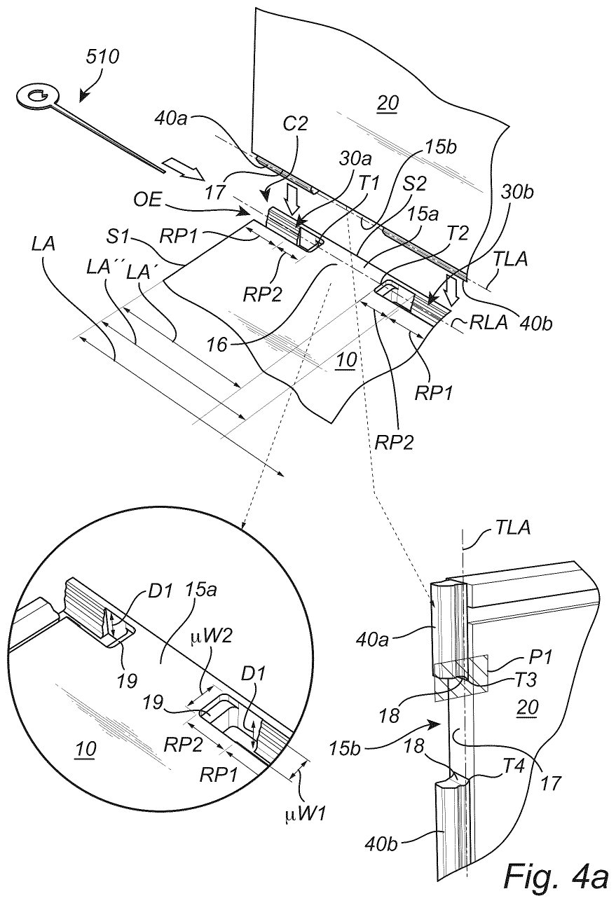

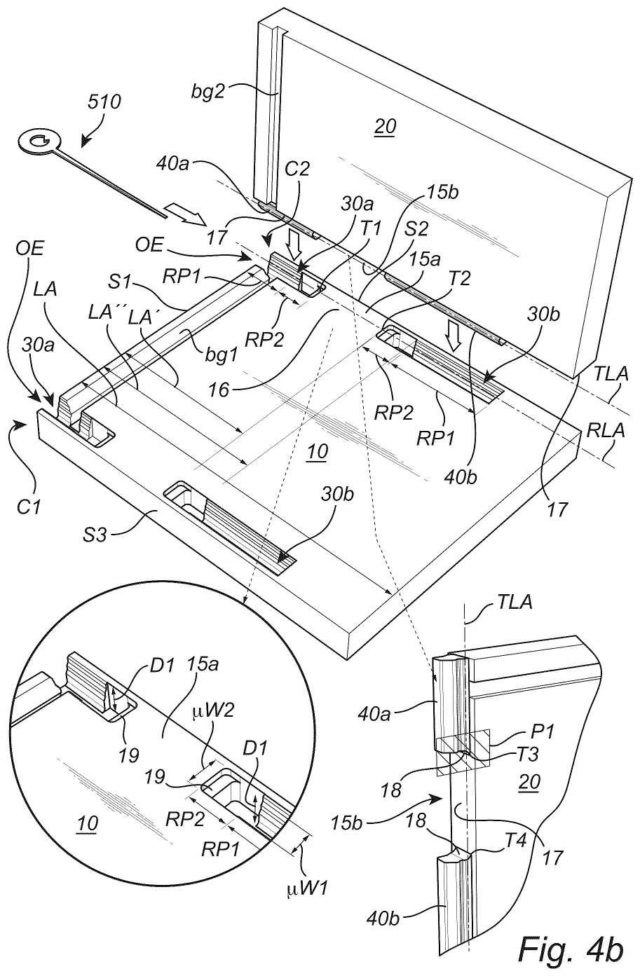

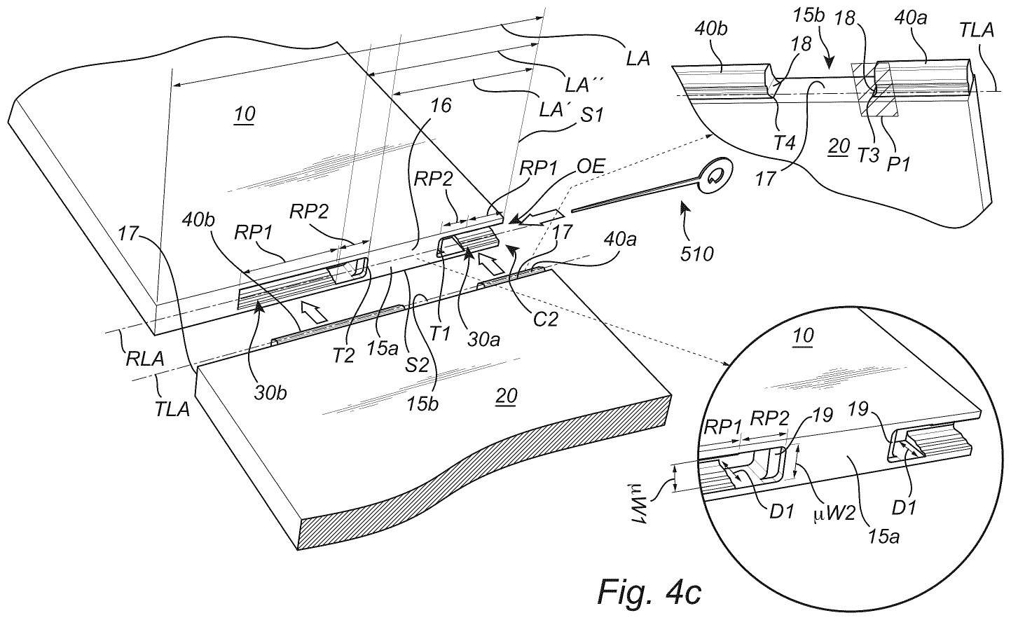

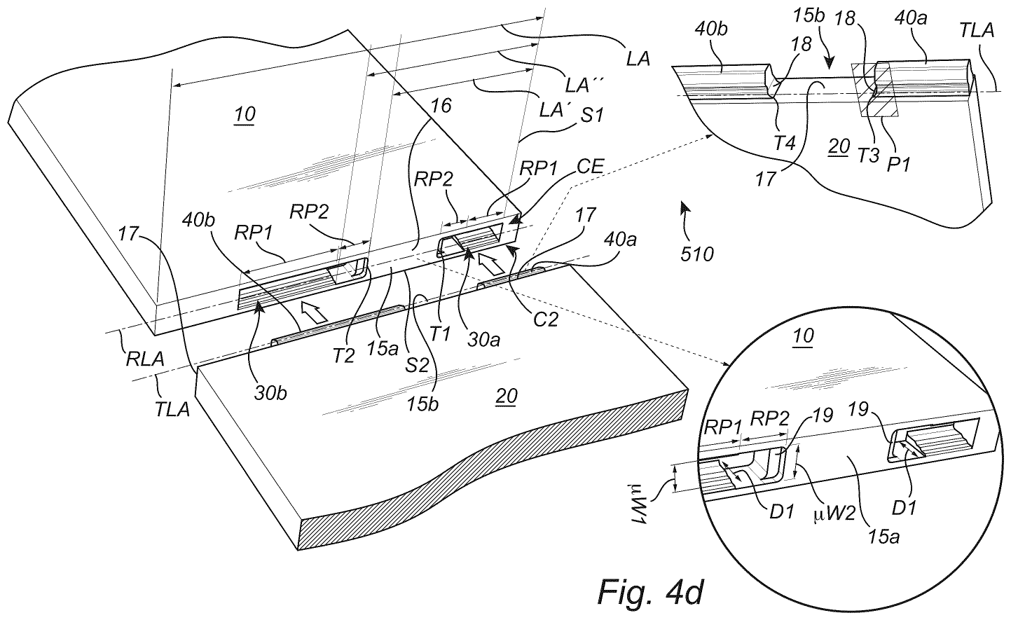

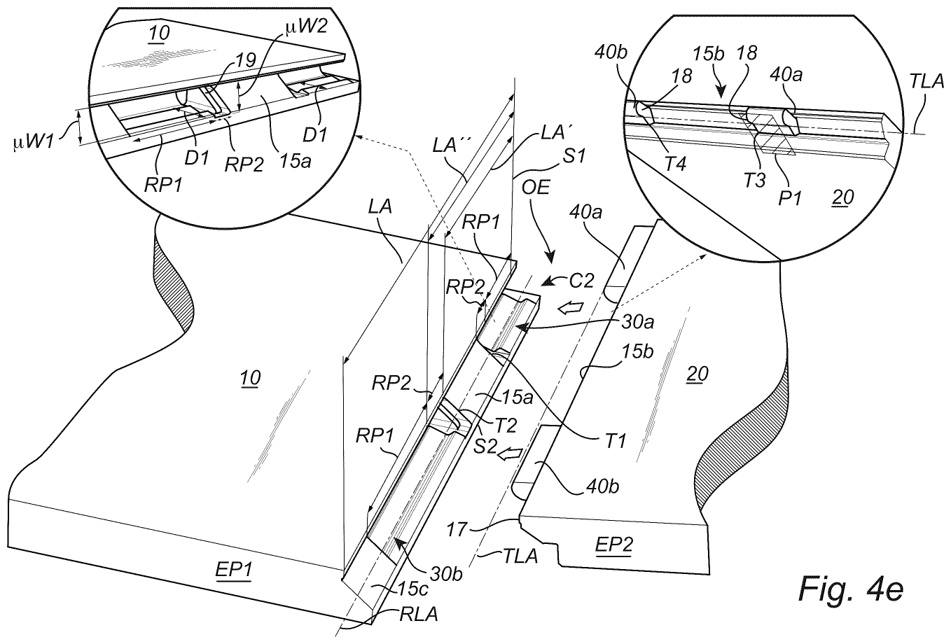

The lower guiding surface 160 transitions into a lateral locking surface 170 extending essentially parallelly to a longitudinal direction LD of the female coupling recess 30. The lateral locking surface 170 is configured to exert a horizontal pressure on the male coupling tongue 40 towards the first side 115 of the female coupling recess 30. The horizontal pressure holds the first and second locking elements 50, 60 of the male coupling tongue 40 and the female coupling recess 30 in engagement with each other in a joined state between the first panel 10 and the second panel 20. The first and second panels 10, 20, may thus be joined at a 90-degree angle as clearly illustrated in e.g. FIG. 4. It should be understood that the first and second panels 10, 20, may be joined at different angles, i.e. oblique or acute angles, besides from the perpendicular angle as illustrated in FIGS. 1-4.

The joining system of the embodiment described with reference to FIGS. 1-4 provides increased multi-directional side stability, while at the same time being less complex to manufacture. A further increased stability and increased strength in the interlocked state of the first and second panels 10, 20, is provided for when having the first locking element 50 comprising an integral protrusion 50 integrally formed in the male coupling tongue 40. E.g. a drawback of prior art joining system is that a separate flexible polymer tongue is typically required for the interlocking of the panels, which has to be pre-fitted during manufacture. This may increase the complexity of the production line and manufacturing process as well as the joining system as such becomes more expensive. The throughput of the production line in mass production may also be more limited. Thus, in addition to providing for a more robust and stronger joining system which can absorb greater force loads in more directions—due to its single-piece integrated construction—the manufacturing thereof is also facilitated. I.e., the neither the male coupling tongue nor the female coupling recess comprises any separate elastic elements for creating the locking, which makes the product easier to manufacture and recycle. Also, the male coupling tongue 40 does not comprise any vertical elasticity slits and is thereby more sturdy and less prone to breaking. The panels 10, 20, may correspond to various parts of pieces of different items to be assembled together utilizing the joining system 1, which for example could be furniture parts such as drawers, wardrobes, shelves, desks, cabinets, tables etc.

The first locking element 50 may comprise a continuously curved bulb-shaped protrusion extending from the male coupling tongue 40. This provides for an improved structural integrity with a reduced risk of unwanted deformations, while a facilitated manufacturing of the first locking element 50 may be provided.

The second locking element 60 may comprise a concave locking groove 60′ conforming at least partly to the bulb-shaped protrusion for interlocking engagement therewith. The bulb-shaped protrusion may thus smoothly engage with the concave locking groove 60′ while maximizing the area of contact between the two, allowing for reducing localized points of increased pressure if a load is applied onto the first or second panel 10, 20.

The upper guiding surface 110 may extend essentially in parallel with a longitudinal direction LD of the female coupling recess 30. The upper guiding surface 110 may extend directly from the second locking element 60 of the female coupling recess 30 in a direction towards an insertion opening of said female coupling recess 30. Such arrangement of the upper guide surface 110 provides for an effective and reliable guiding of the first locking element 50 into the correct interlocking position in the adjacent second locking element 60 along the longitudinal direction LD.

The lower guiding surface 160 may be curved. Having a curved guiding surface 160 provides for a facilitated guiding of the male coupling tongue 40 into the final interlocked state in the female coupling recess 30, as the guiding surface 160 may exert a force in gradually changing directions against the male coupling tongue 40 for deflection thereof as described above.

The male coupling tongue 40 may be integrally formed with the first panel 10 and the female coupling recess 30 may be integrally formed with the second panel 20. This provides for a robust joining system being materially integrated and without any separate components, which thus can absorb higher force loads, as well as a facilitated manufacturing and recycling of the joining system.

The male coupling tongue 40 may comprise side support surfaces 181′,181″ which may extend parallelly to the longitudinal direction LD of the male coupling tongue 40. The side support surfaces 181′,181″ are arranged for direct abutment against support surfaces 171′,171″ on the sides of the female coupling recess, also being parallel to the longitudinal direction LD of the female coupling recess 30. This provides for symmetrical side stability and bending resistance in a locked and joined state between the first panel 10 and the second panel 20.

A width A at a base portion of the male coupling tongue 40 may be wider than a width B of the male coupling tongue 40 at the height (perpendicularly to the longitudinal direction LD) of the first locking element 50, as illustrated in FIGS. 1 and 2. Having a wider base width A provides for a further increased side stability of the joining system. The width B may be wider than an average width of the distal, lower portion LD. The width B may 20%, 30% or 40% wider than the average width of the distal, lower portion LD.

FIG. 2 shows a side view of the embodiment of the joining system shown in FIG. 1, only here in a state just before the male coupling tongue of the second panel becomes fully engaged in the female coupling recess of the first panel. The lower guiding surface 160 has forced the male coupling tongue 40 to resiliently deflect in a curved J-shaped deflection movement towards said first side 115 of the female coupling recess 30, until the first locking element 50 of the male coupling tongue 40 snaps together with the matching second locking element 60 of the female coupling recess 30. A facilitated insertion of the male coupling tongue 40 into the interlocked position may thus be provided, while achieving a robust and stable interlocked state.

FIG. 3a shows a side view of the joining system of FIG. 1, only here in a state in which the male coupling tongue 40 of the second panel 20 has been fully inserted and engaged in the female coupling recess 30 of the first panel 10, such that the snap-lock has been created. In FIG. 3a, the insertion portion (as described with reference to FIG. 3b) of the coupling release rod 510 of FIG. 3b has been inserted into the coupling release channel 600 of the female coupling recess 30, such that preparations have been made for further insertion of the coupling release rod 510 into the coupling release channel 600 for the disconnection of the second panel 20 from the first panel 10. The insertion portion of the coupling release rod 510 have a rectangular, elongated cross-section.

FIG. 3b shows a sideview of a wedge-shaped coupling release rod according to one embodiment. A tapering unlocking section 590 exhibits a linear tapering profile. The coupling release rod 510 comprises an introductory section 580 with a constant cross-sectional area, extending from a tip portion 520 to the tapered unlocking section 590 with an increasing cross-sectional area towards the base portion 530 of the coupling release rod 510. The length (Lt) of the tapered unlocking section 590 may exceed the length (Li) of the introductory section 580. The introductory section 580 may provide for facilitated guiding of the coupling release rod 510 into the coupling release channel 600 before the tapered unlocking section 590 start to push the male coupling tongue 40 for release. The length Li of the introductory section may be from 30% to 70% of the length Lt of the tapered unlocking section 590 in some examples. The length Li of the introductory section 580 may in one advantageous example be 40% of the length Lt of the tapered unlocking section 590.

FIG. 3c shows a side view of the joining system of FIG. 1, only here in a state in which the unlocking section 590 of the wedge-shaped coupling release rod 510 has entered the coupling release channel 600, creating a vertical force forcing on the male coupling tongue 40 causing the male coupling tongue 40 to disengage from the female coupling recess 30 and thereby deliberately separating the second panel 20 from the first panel 10.

FIG. 4a shows a perspective overview of a perpendicular engaging or disengaging of a second panel 20 from a first panel 10 in a perspective view. FIG. 4a also shows the coupling release rod 510 as well as enlargements of a first positioning portion 15a of the first panel 10 and of a second positioning portion 15b of the second panel 20. In the embodiment of FIG. 4a, the first panel 10 comprises a first and second female coupling recess 30a,30b having a recess length axis RLA. The first and second female coupling recess 30a,30b are formed as integral portions of the first panel 10, which in the embodiment of FIG. 4a means that they are milled from the same piece of material, without any additional parts added. In the embodiment shown in FIG. 4a, the first female coupling recess 30a is shorter than the second female coupling recess. In the embodiment shown in FIG. 4a, the first female coupling recess 30a has a length which is less than 50% of the length of the second female coupling recess 30b, along the recess length axis RLA.

The first panel 10 further comprises a first positioning portion 15a being formed as an integral portion of the first panel 10, which in the embodiment of FIG. 4a means that it is an un-milled section having the same height as the portion of the first panel surrounding the first and second female coupling recesses 30a,30b.

The second panel 20 comprises a first and second male coupling tongue 40a,40b having a tongue length axis TLA and being formed as integral portions of the second panel 20, which in the embodiment of FIG. 4a means that they are milled from the same piece of material, without any additional parts added. The second panel further comprises a second positioning portion 15b being formed as an integral portion of the second panel 20, and being placed between the first and second male coupling tongues 40a,40b. In the embodiment of FIG. 4a, the second positioning portion 15b is a portion void of male coupling tongues. The first male coupling tongue 40a is configured to be coupled to the first female recess 30a, and the second male coupling tongue 40b is configured to be coupled to the second female recess 30b, for creating an interlocking engagement between the first and second panels 10,20.

Having a first and second female coupling recesses 30a,30b, and a first and second male coupling tongue 40a,40b also creates redundancy in the joining system. If one of the joints (30a,40a) of (30b,40n) is weaker, the other joint could absorb a larger portion of the load.

The first positioning portion 15a is configured to be placed opposite to, and in this embodiment engage the second positioning portion 15b as the interlocking engagement is created, such that the engagement between the first and second positioning portions 15a,15b hinders the movement of the second panel 20 in relation to the first panel 10, along the recess length axis RLA.

The first and second female coupling recess 30a,30b have a depth D1, such that the first and second male coupling tongues 40a,40b can be received in the first and second female coupling recess 30a,30b for creating the interlocking engagement. The first positioning portion 15a hinders the movement of the second panel 20 in relation to the first panel 20 along the recess length axis RLA by not having a depth capable of receiving any one of the first and second male coupling tongues 40a,40b. The positioning portions 15a,15b helps the person connecting the first and second panels to ensure that the first and second panels are connected in the right position along the recess length axis RLA and tongue length axis TLA, which makes it significantly harder to erroneously connect the second panel 20 to the first panel 10, which ensures that the long-term functionality as well as the aesthetics of the combined item becomes as intended.

According to the embodiment shown in FIG. 4a, the un-milled first positioning portion 15a is placed relatively close to one side S1 of the first panel, which makes the corner portions C1,C2 stronger, as the first female coupling recess 30a affecting the strength of the first and second corners C1,C2 (as the material left after the recesses have been milled is substantially thinner) becomes shorter. In the embodiment shown in FIG. 4a, the first panel 10 has a first length LA along the recess length axis RLA, and the first positioning portion 15a is placed entirely within the first half LA′ of the first length LA. In the embodiment of FIG. 4a, the first positioning portion 15a is placed entirely within the first ⅓ LA″ of the first length LA.

The first panel 10 comprises first planar surface 16 extending on at least two sides of the first and second female coupling recess 30a,30b. In the embodiment of FIG. 4a, the planar surface 16 is an entirely un-milled planar surface extending from a second side S2 to a third side S3 of the first panel 10. However, in alternative embodiments it is conceivable that the planar surface is a partially milled planar surface, e.g. for the purpose of making sure that the planar surface have a specific height, i.e. that the first panel 10 have a specific thickness, which is important when creating the exact millings forming the first and second female coupling recess 30a,30b. The planar surface 16 is configured to engage a second surface 17 extending on at least two sides of the first and second male coupling tongues 40a,40b, such that the first and second planar surfaces engage and rest against each other creating additional stability in the joint.

In the embodiment shown in FIG. 4a, the first positioning portion 15a comprises the planar surface 16, such that the planar surface 16 extends from one side T1 of the first female coupling recess 30a, over the first positioning portion 15a to one side T2 of the second female coupling recess 30b. Similarly, the second positioning portion 15b comprises the second surface 17, such that the second surface 17 extends from one side T3 of the first male coupling tongue 40a, over the second positioning portion 15b to one side T4 of the second male coupling tongue 40b.

In the embodiment shown in FIG. 4a, the first and second male coupling tongues 40a,40b comprises a curvature or chamfer 18 extending between the first and second male coupling tongues 40a,40b and the second surface 17, along a plane P1 extending from the tongue length axis TLA. The curvature or chamfers 18 makes it easier to manufacture the male coupling tongues and also increases the strength of the male coupling tongues. The first and second female coupling recess 30a,30b each comprises a clearance recess 19 configured to receive the curvature or chamfer 18. In the embodiment of FIG. 4a, the clearance recess 19 is less than ⅓ of the depth D1 of the first and second female coupling recess 30a,30b.

In the embodiment shown in FIG. 4a, the first female coupling recesses 30a comprises an open-end OE, which means that the first female coupling recess 30a extends from an end surface of the first panel 10, being the first side S1. This enables the coupling release rod 510 to access and be positioned in the coupling release channel (as described with reference to FIGS. 1-3a,3c) for decoupling the second panel 20 from the first panel 10.

At least one of the first and second female coupling recesses 30a,30b comprises a first recess portion RP1 comprising locking means and a second recess portion RP2 devoid of locking means. The first recess portion RP1 has an average width μW1, and the second recess portion RP2 has an average width μW2. The average width μW2 of the second recess portion RP2 is wider than the average width μW1 of the first recess portion RP1. This enables a milling tool for milling the first and second female coupling recesses 30a,30b to enter and exit the recess at the second recess portion RP2.

In the embodiment shown in FIGS. 4a-4e, the length of the first positioning portion 15a is slightly shorter than the length of the first female coupling recess 30a, along the direction of the recess length axis RLA. Also, the first positioning portion 15a is considerably shorter than the length of the second female coupling recess 30a, along the direction of the recess length axis RLA. As such, the first positioning portion 15a is less than half the combined length of the first and second female coupling recesses 30a, 30b along the direction of the recess length axis RLA. More specifically, the first positioning portion 15a is less than ⅓ the combined length of the first and second female coupling recesses 30a, 30b along the direction of the recess length axis RLA and less than ¼ the combined length of the first and second female coupling recesses 30a, 30b along the direction of the recess length axis RLA. As such, more than half of the length of the first panel along the direction of the recess length axis RLA comprises the locking portions of the joining system, which creates a strong mechanical lock between the first and second panels 10,20.

In the embodiment shown in FIGS. 4a-4e, the length of the planar surface 16 is slightly shorter than the length of the first female coupling recess 30a, along the direction of the recess length axis RLA. Also, the planar surface 16 is considerably shorter than the length of the second female coupling recess 30a, along the direction of the recess length axis RLA. As such, the planar surface 16 is less than half the combined length of the first and second female coupling recesses 30a, 30b along the direction of the recess length axis RLA. More specifically, the planar surface 16 is less than ⅓ the combined length of the first and second female coupling recesses 30a, 30b along the direction of the recess length axis RLA and less than ¼ the combined length of the first and second female coupling recesses 30a, 30b along the direction of the recess length axis RLA.

The embodiment shown in FIGS. 4a-4e includes only one first positioning portion 15a and one second positioning portion 15b. In alternative embodiments, there may be several positioning portions along the recess length axis RLA and tongue length axis TLA. In one embodiment, a first panel comprises two or more first positioning portions and the second panel comprises two or more second positioning portions. In one embodiment, a first panel comprises three or more first positioning portions and the second panel comprises three or more second positioning portions. The addition of further positioning portions further reduces the risk that first and second panel will shift in the direction along the recess length axis RLA and tongue length axis TLA when connected.

The joining system could in any of the embodiments herein be a joining system for joining furniture parts, and in which case the first panel could be a first furniture part and the second panel could be a second furniture part. The joining system could in other embodiments be a joining system for structural components in house construction of elements for constructing the inner or outer walls of a house.

FIG. 4b shows a perspective overview of the engaging or disengaging of a second furniture part 20 from a first furniture part 10, using the joining system as described with reference to FIGS. 1-4a, for joining the panels which in this embodiment constitute furniture parts. FIG. 4b also shows the coupling release rod 510 as well as enlargements of a first positioning portion 15a of the first furniture part 10 and of a second positioning portion 15b of the second furniture part 20. In the embodiment of FIG. 4b, the first furniture part 10 comprises a first and second female coupling recess 30a,30b having a recess length axis RLA. The first and second female coupling recess 30a,30b are formed as integral portions of the first furniture part 10, which in the embodiment of FIG. 4b means that they are milled from the same piece of material, without any additional parts added. In the embodiment shown in FIG. 4b, the first female coupling recess 30a is shorter than the second female coupling recess. In the embodiment shown in FIG. 4b, the first female coupling recess 30a has a length which is less than 50% of the length of the second female coupling recess 30b, along the recess length axis RLA.

The first furniture part 10 further comprises a first positioning portion 15a being formed as an integral portion of the first furniture part 10, which in the embodiment of FIG. 4b means that it is an un-milled section having the same height as the portion of the first furniture portion surrounding the first and second female coupling recesses 30a,30b.

The second furniture part 20 comprises a first and second male coupling tongue 40a,40b having a tongue length axis TLA and being formed as integral portions of the second furniture part 20, which in the embodiment of FIG. 4b means that they are milled from the same piece of material, without any additional parts added. The second furniture part further comprises a second positioning portion 15b being formed as an integral portion of the second furniture part 20, and being placed between the first and second male coupling tongues 40a,40b. In the embodiment of FIG. 4b, the second positioning portion 15b is a portion void of male coupling tongues. The first male coupling tongue 40a is configured to be coupled to the first female recess 30a, and the second male coupling tongue 40b is configured to be coupled to the second female recess 30b, for creating an interlocking engagement between the first and second furniture part 10,20.

The first positioning portion 15a is configured to engage the second positioning portion 15b as the interlocking engagement is created, such that the engagement between the first and second positioning portions 15a,15b hinders the movement of the second furniture part 20 in relation to the first furniture part 10, along the recess length axis RLA.

The first and second female coupling recess 30a,30b have a depth D1, such that the first and second male coupling tongues 40a,40b can be received in the first and second female coupling recess 30a,30b for creating the interlocking engagement. The first positioning portion 15a hinders the movement of the second furniture part 20 in relation to the first furniture part 20 along the recess length axis RLA by not having a depth capable of receiving any one of the first and second male coupling tongues 40a,40b. The positioning portions 15a,15b helps the person connecting the first and second furniture parts to ensure that the first and second furniture parts are connected in the right position along the recess length axis RLA and tongue length axis TLA, which makes it significantly harder to erroneously connect the second furniture part 20 to the first furniture part 10, which ensures that the long-term functionality as well as the aesthetics of the furniture becomes as intended.

According to the embodiment shown in FIG. 4b, the un-milled first positioning portion 15a is placed relatively close to one side S1 of the first furniture part, which makes the corner portions C1,C2 stronger, as the first female coupling recess 30a affecting the strength of the first and second corners C1,C2 (as the material left after the recesses have been milled is substantially thinner) becomes shorter. In the embodiment shown in FIG. 4b, the first furniture part 10 has a first length LA along the recess length axis RLA, and the first positioning portion 15a is placed entirely within the first half LA′ of the first length LA. In the embodiment of FIG. 4b, the first positioning portion 15a is even placed entirely within the first ⅓ LA″ of the first length LA.

The first furniture part 10 comprises first planar surface 16 extending on at least two sides of the first and second female coupling recess 30a,30b. In the embodiment of FIG. 4b, the planar surface 16 is an entirely un-milled planar surface extending from a second side S2 to a third side S3 of the first furniture part 10. However, in alternative embodiments it is conceivable that the planar surface is a partially milled planar surface, e.g. for the purpose of making sure that the planar surface have a specific height, i.e. that the first furniture part 10 have a specific thickness, which is important when creating the exact millings forming the first and second female coupling recess 30a,30b. The planar surface 16 is configured to engage a second surface 17 extending on at least two sides of the first and second male coupling tongues 40a,40b, such that the first and second planar surfaces engage and rest against each other creating additional stability in the joint.

In the embodiment shown in FIG. 4b, the first positioning portion 15a comprises the planar surface 16, such that the planar surface 16 extends from one side T1 of the first female coupling recess 30a, over the first positioning portion 15a to one side T2 of the second female coupling recess 30b. Similarly, the second positioning portion 15b comprises the second surface 17, such that the second surface 17 extends from one side T3 of the first male coupling tongue 40a, over the second positioning portion 15b to one side T4 of the second male coupling tongue 40b.

In the embodiment shown in FIG. 4b, the first and second male coupling tongues 40a,40b comprises a curvature or chamfer 18 extending between the first and second male coupling tongues 40a,40b and the second surface 17, along a plane P1 extending from the tongue length axis TLA. The curvature or chamfers 18 makes it easier to manufacture the male coupling tongues and also increases the strength of the male coupling tongues. The first and second female coupling recess 30a,30b each comprises a clearance recess 19 configured to receive the curvature or chamfer 18. In the embodiment of FIG. 4b, the clearance recess 19 is less than ⅓ of the depth D1 of the first and second female coupling recess 30a,30b.

In the embodiment shown in FIG. 4b, the first female coupling recesses 30a comprises an open-end OE, which means that the first female coupling recess 30a extends from an end surface of the first furniture part 10, being the first side S1. This enables the coupling release rod 510 to access and be positioned in the coupling release channel (as described with reference to FIGS. 1-3a,3c) for decoupling the second furniture part 20 from the first furniture part 10.

At least one of the first and second female coupling recesses 30a,30b comprises a first recess portion RP1 comprising locking means and a second recess portion RP2 devoid of locking means. The first recess portion RP1 has an average width μW1, and the second recess portion RP2 has an average width μW2. The average width μW2 of the second recess portion RP2 is wider than the average width μW1 of the first recess portion RP1. This enables a milling tool for milling the first and second female coupling recesses 30a,30b to enter and exit the recess at the second recess portion RP2.

In FIG. 4b, the first furniture part 10 further comprises a groove bg1 for a back portion of the furniture item. The groove bg1 of the first furniture part extends perpendicularly to the recess length axis RLA. The groove bg1 may comprises a mechanical lock for fixating the back portion in a vertical direction along the plane extension of the back portion, after insertion. In the alternative, the groove bg1 may be a groove only stabilizing the back portion by locking the back portion in a horizontal direction (i.e. in a direction parallel to the recess length axis RLA). The second furniture part 20 also comprises a groove bg2 for the back portion of the furniture item. The groove bg2 of the second furniture part extends perpendicularly to the tongue length axis TLA. The groove bg2 may comprises a mechanical lock for fixating the back portion in a vertical direction along the plane extension of the back portion, after insertion. In the alternative, the groove bg2 may be a groove only stabilizing the back portion by locking the back portion in a horizontal direction (i.e. in a direction parallel to the recess length axis RLA). The back portion being locked in the grooves creates additional stability of the furniture part.

In FIG. 4b, the female coupling recesses and the male coupling tongues are shown as the female coupling recesses and the male coupling tongues described with reference to FIGS. 1-3a, 3c. However, in alternative embodiments, it is conceivable that the female coupling recesses and the male coupling tongues are of a different design.

FIG. 4c shows a perspective overview of a parallel engaging or disengaging of a second panel 20 from a first panel 10 in a perspective view. The application could for example be for connecting two panels 10,20 being parts of a table top. FIG. 4c also shows the coupling release 510 rod as well as enlargements of a first positioning portion 15a of the first panel 10 and of a second positioning portion 15b of the second panel 20. In the embodiment of FIG. 4c, the second panel 20 is structurally the same as the second panel in the embodiments shown in FIGS. 4a and 4b. However, the first panel 10 is different in that the first and second female coupling recesses 30a,30b are placed in the end portion of the first panel 10 for enabling the first and second panel to be joined in a direction perpendicular to the extension of the planes of the first and second panels 10,20. In the same way as an FIGS. 4a and 4b, the engagement of the positioning portions 15a,15b of the first and second panels 10,20 positions the first panel 10 relative to the second panel 20, which makes it easier to obtain correct assembly of the first and second panels. Also, the engagement of the positioning portions 15a,15b hinders the shift between the first and second panel 10,20 in the direction of the recess length axis RLA and the tongue length axis TLA. Other suitable applications for the parallel engaging or disengaging is for the construction of larger planar elements for constructing the inner or outer walls of a house.

FIG. 4d shows a perspective overview of a parallel engaging or disengaging of a second panel 20 from a first panel 10 in a perspective view, very similar to the embodiment shown in FIG. 4c. The difference being that in FIG. 4d, the first panel 10 has a closed end CE. The closed end CE will create a smoother and more esthetically appealing look from the side, but has the disadvantage that the joining system (the first female coupling recesses 30a and the first male coupling tongue 40a) cannot be accessed from the side (S1) of the panels 10,20. The embodiment of FIG. 4d can thus not be used in connection with a coupling release for unlocking the locking system.

FIG. 4e shows a perspective overview of an engaging or disengaging of a second panel 20 from a first panel 10. In the embodiment of FIG. 4e, the panels 10, 20 are engaged by means of angling, but the end result after joining will have the same planar surfaces as in the embodiments of FIGS. 4c and 4d. In the angling enabled locking system could for example be the locking system disclosed in WO2019/211460 (Markovski et al.). After the male coupling tongues 40a,40b have been inserted into the female coupling recesses 30a,30b, at an angle, the second panel can be displaced in relation to the first panel, along the recess length axis RLA and the tongue length axis TLA. As such, the male coupling tongues 40a,40b can slide in the female coupling recesses 30a,30b along the recess length axis RLA and the tongue length axis TLA. As such, the second panel 20 can be engaged with the first panel 10 in a position in which the end portions (such as EP1 and EP2) of the first and second panels 10,20 are not aligned. After the male coupling tongues 40a,40b have been introduced in the female coupling recesses 30a,30b at an angle, the second panel 20 can be displaced in relation to the first panel 10, until at least one of the first and second male coupling tongues 40a,40b, comes into contact with the first positioning portion 15a or a third positioning portion 15c, which hinders further movement of the male coupling tongues 40a,40b in the female coupling recesses 30a,30b along the recess length axis RLA and the tongue length axis TLA. At this position, the end portions (such as EP1 and EP2) are aligned and the second panel 20 can be folded in relation to the first panel 10 for securing the mechanical lock, at the aligned position. This could for example be very useful for connecting long panels in which it is difficult to se the alignment of the end portions (such as EP1 and EP2) when holding the center of the panel. This could for example be useful for installing floor panels or wall panels which may be long and in which alignment of the end portions are of essence.

1-16. (canceled)

17. A joining system for panels, comprising a first panel and a second panel configured to be joined with the first panel, wherein:
the first panel comprises a first female coupling recess and a second female coupling recess having a recess length axis, and a first positioning portion disposed between the first female coupling recess and the second female coupling recess along the recess length axis;
the second panel comprises a first male coupling tongue and a second male coupling tongue having a tongue length axis, and a second positioning portion disposed between the first male coupling tongue and the second male coupling tongue;
the first male coupling tongue is configured to be coupled to the first female coupling recess and the second male coupling tongue is configured to be coupled to the second female coupling recess to interlock the first panel and the second panel; and
the first positioning portion is configured to be positioned opposite the second positioning portion to prevent movement of the second panel in relation to the first panel along the recess length axis.

18. The joining system according to claim 17, wherein the first female coupling recess and the second female coupling recess have a depth that is greater than the depth of the first positioning portion.

19. The joining system according to claim 17, wherein the first panel has a first length along the recess length axis, and the first positioning portion is placed entirely within a first half of the first length.

20. The joining system according to claim 19, wherein the first positioning portion is placed entirely within a first third of the first length.

21. The joining system according to claim 17, wherein the first panel comprises a first planar surface extending on at least two sides of the first female coupling recess and the second female coupling recess, and the first planar surface is configured to engage a second surface extending on at least two sides of the first male coupling tongue and the second male coupling tongue.

22. The joining system according to claim 21, wherein the first positioning portion comprises the first planar surface, such that the first planar surface extends from at least one side of the first female coupling recess over the first positioning portion to at least one side of the second female coupling recess.

23. The joining system according to claim 21, wherein the second positioning portion comprises the second surface, such that the second surface extends from at least one side of the first male coupling tongue over the second positioning portion to at least one side of the second male coupling tongue.

24. The joining system according to claim 21, wherein the first male coupling tongue and the second male coupling tongue comprises a curved portion extending between the first male coupling tongue, the second male coupling tongue, and the second surface, along a plane extending from the tongue length axis.

25. The joining system according to claim 24, wherein at least one of the first female coupling recess and the second female coupling recess comprises a clearance recess configured to receive the curved portion.

26. The joining system according to claim 17, wherein the first female coupling recess comprises an open end.

27. The joining system according to claim 17, wherein at least one of the first female coupling recess and the second female coupling recess comprises:
a first recess portion comprising a lock; and
a second recess portion.

28. The joining system according to claim 17, wherein an average width of the second recess portion is wider than an average width of the first recess portion.

29. The joining system according to claim 17, wherein the first male coupling tongue and the second male coupling tongue comprise a flexible locking protrusion integrally formed in the male coupling tongue, and wherein the first female coupling recess and the second female coupling recess comprise a locking groove configured to receive the flexible locking protrusion.

30. The joining system according to claim 29, wherein the first female coupling recess and the second female coupling recess comprise a coupling release channel configured to receive a coupling release rod, such that the interlocked first panel and second panel are configured to be released by the coupling release rod pressing on the flexible locking protrusion of the male coupling tongue.

31. The joining system according to claim 17, wherein the first positioning portion is configured to engage the second positioning portion when the first panel and the second panel interlock to stabilize a joint between the first panel and the second panel.

32. The joining system according to claim 17, wherein the first panel is a first furniture part and the second panel is a second furniture part.

33. The joining system according to claim 17, wherein the first male coupling tongue and the second male coupling tongue are integral portions of the second panel.

34. The joining system according to claim 27, wherein the second recess portion does not have a lock.
